(19) United States
(12) Patent Application Publication
(10) Pub. No.: US 2011/0040691 A1
(43) Pub. Date: Feb. 17, 2011

(54) SYSTEM AND METHOD FOR VERIFIED PRESENCE MARKETPLACE

(75) Inventors: Ronald Martinez, San Francisco, CA (US); Marc Eliot Davis, San Franciso, CA (US); Simon P. King, Berkeley, CA (US); Christopher William Higgins, Portland, OR (US); Chris Kalaboukis, San Jose, CA (US); Duane R. Valz, Emeryville, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc.

(21) Appl. No.: 12/540,098

(22) Filed: Aug. 12, 2009

(51) Int. Cl. G06Q 30/00; G06Q 20/00

(52) U.S. Cl. 705/80

(57) ABSTRACT

A system and method for a verified presence data marketplace. Offers for verified location data are received wherein each offer comprises an identification of at least one target user, at least one data granularity level and data reliability level and at least one offer payment term. Location data relating to the target users is retrieved from a plurality of location data sources and the reliability of the data is then verified and the data is then stored on a computer readable medium. At least one bid for verified location data from an entity is received wherein the bid relates to the offers for verified location data. An acceptance of the bid is then processed. The verified location data relating to the bid is then retrieved and is transmitted over the network to the bidding entity and the target users are paid according to the terms of the bid payment offer.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD OF THE INVENTION

The present invention relates to systems and methods for acquiring and marketing user presence data, and more specifically, to a electronic verified presence data marketplace.

### BACKGROUND OF THE INVENTION

Verified location data is a potentially valuable commodity. For example, retailers may have an interest in the composition of consumers who patronize a given location and when such consumers are present in a given location. Location data could be used to test the effectiveness of an advertising campaign, for example by increases in traffic. A municipality may have an interest in traffic patterns on a given road, public transportation route, pedestrian path and so forth. Users may have an interest in selling their personal location data to commercial entities, but doing so may be difficult without a structured marketplace for such data that insures the reliability of the data at the same time.

### SUMMARY OF THE INVENTION

In one embodiment, the invention is a method. At least one offer for verified location data is received over a network, wherein each offer comprises an identification of at least one target user, at least one offer data granularity level, at least one offer data reliability level and at least one offer payment term. Location data relating to the at least one offer target user is retrieved over the network, from a plurality of location data sources. The reliability of the retrieved location data is then verified, using at least a first computing device and the verified data is then stored on a computer readable medium using at least a second computing device, wherein the verified location data is stored in association with the identification of the target users, a location data granularity level, and a location data reliability level. At least one bid for verified location data from an entity is received, over a network, wherein the bid relates to the offers for verified location data, and wherein each bid comprises an identification of the entity, an identification of at the least one target user, at least one bid data granularity level, at least one bid data reliability level and at least one payment offer. An acceptance of the bid is then processed using at least a third computing device. The verified location data relating to the bids for verified location data is then retrieved from the computer readable medium, and are transmitted over a network to the bidding entity and the target users are paid according to the terms of the payment offers.

In one embodiment, the invention is a system. The system comprises a group of managers, each comprising one or more processors programmed to execute software code retrieved from a computer readable storage medium storing software for various functions. The system comprises an offer manager for receiving, over a network, offers for verified location data, wherein each offer comprises an identification of at least one target user, at least one data granularity level, at least one data reliability level and at least one payment term; a location data manager for retrieving, over a network, location data relating to target users from a plurality of location data sources, verifying the reliability of the retrieved location data and storing the verified location data on a second computer readable medium, wherein the verified location data is stored in association with an identification of at least one target user, at least one data granularity level, and at least one data reliability level; a bid manager for receiving, over a network, bids for verified location data from entities, wherein each bid relates to the at least one offer for verified location data, wherein each bid comprises an identification of the entity, an identification of at the least one target user, at least one bid data granularity level, at least one bid data reliability level and at least one payment offer, the bid manager being further configured to process acceptances of bids for verified location data; and a data transmission manager for retrieving verified location data relating to accepted bids from the second computer readable medium and for transmitting such verified location data to entities whose bids have been accepted and for paying target users according to the terms of the accepted bids.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates one embodiment of communications and sensor networks that could be used to support at least one embodiment of the present invention.

FIG. 2 illustrates one embodiment of a process for verified presence tracking using at least one embodiment of the system disclosed herein.

FIG. 3 illustrates one embodiment of a verified presence tracking engine capable of supporting at least one embodiment of the process described in FIG. 2.

FIG. 4 illustrates one embodiment of a process 4000 for a verified presence data marketplace using at least one embodiment of the system disclosed herein.

FIG. 5 illustrates one embodiment of a verified presence data marketplace engine capable of supporting at least one embodiment of the process described in FIG. 4.

### DETAILED DESCRIPTION

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and/or communication facilities. By way of example, and not limitation, the term “server” can refer to a single, physical processor with associated communications and data storage and database facilities, or it can refer to a networked or clustered complex of processors and/or associated network and storage devices, as well as operating software and one or more database systems and applications software which support the services provided by the server.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application or a manager.

In one embodiment, the present invention includes to a verified presence tracking system that tracks the locations of users using multiple sources for location data. Such sources can include various types of sensors, data supplied by other users and third party location data providers. Using a variety of sensor and user inputs, the verified presence tracking system can track users' locations with varying degrees of confidence, scoring available corroborative data by source and reliability and, when necessary, authenticating the presence of one or more users at a location by seeking additional corroborating sensors to actively verify and certifying both user identity and user location/proximity data.

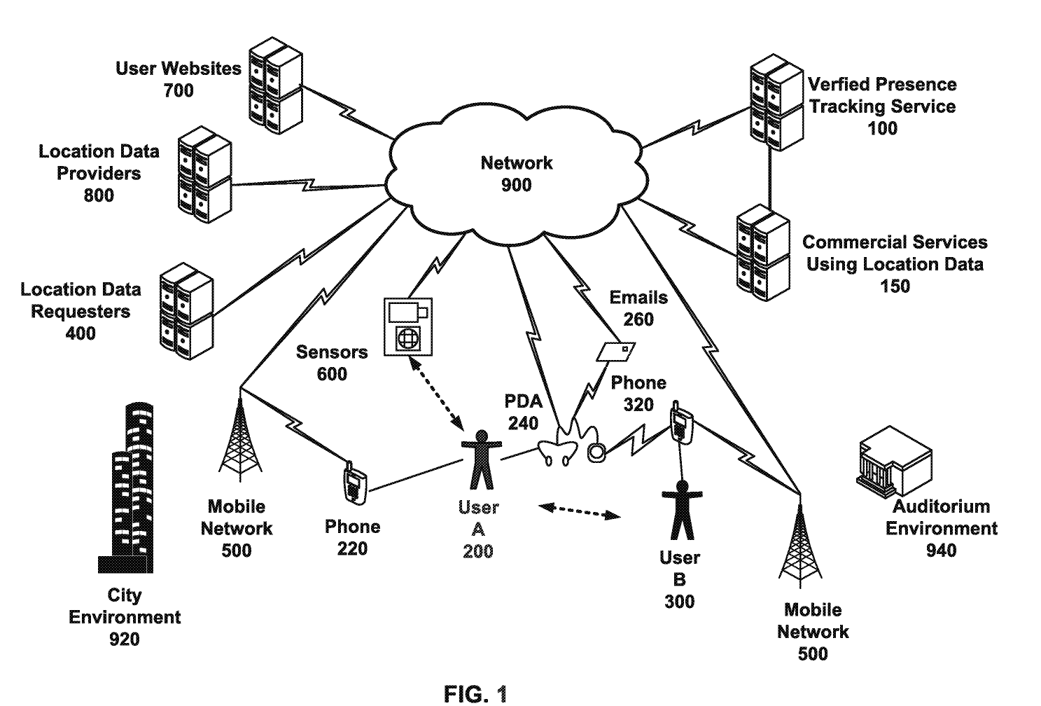

FIG. 1 illustrates one embodiment of communications and sensor networks that could be used to support at least one embodiment of the present invention.

A verified presence tracking service 100 is hosted on at least one server. The server is connected to at least one network 900 through which the verified presence tracking service can receive location and location verification data as well as location data requests regarding a plurality of users, such as User A 200 and User B 300. In one embodiment, the network 900 includes connectivity to the Internet, and can additionally include connectivity to one or mobile networks 500 and one or more wireless or wireline sensor networks 600. Sensor networks may be physically or logically organized into networks across various telecommunications or communication networks.

In one embodiment, the verified presence tracking service 100 is configured to receive location data requests from one or more location data requesters 400. Such location data requesters 400 could be individual users such as User A 200 and User B 300. Such location data requesters 400 could be organizations, such as retailers and service providers that use location data for commercial purposes, such as promotion verification. Such location data requesters 400 could be government entities, such as law enforcement agencies that use location data for law enforcement purposes, such as locating a missing person or tracking a fugitive. Location data requests can be submitted using any conventional technique capable of transmitting data over the Internet. In one embodiment, location requests can be submitted though a web enabled interface, such as an HTML page. In one embodiment, location requests can be submitted via software running on a user device using an API.

In one embodiment, various commercial services 150 which use verified location data 150 could be integrated with the verified presence tracking service 100 to provide enhanced services. One such service could be a verified presence data marketplace. In one embodiment, the commercial services 150 are provided by the same service provider that provides verified presence tracking services 100. In another embodiment, the commercial services 150 may simply be another type of location data requester 400. In one embodiment, commercial services using location data 150 could be integrated with the verified presence tracking services 100 on the same server or cluster of servers.

The data relating to the location of User A 200 and User B 300 can be obtained from a variety of sources including humans and devices such as cellular telephones, mobile computing or gaming devices, appliances or vending machines, private or public vehicles, private or public buildings and sensors. Location data could be a stated location by the user or the user's device. In the illustrated example, user A 200 may engage in various online activities 700 that can provide location data. For example, user A 200 belong to one or more user websites such as a social networking website (such as the Facebook website) or a microblogging site (such as the Twitter website.), personal blogs or websites may also contain content created or annotated by the user and published on an interconnected network for consumption and enjoyment by other users. The user's online activities 700 such as what web sites are visited, how long they are visited for, and what is clicked on or interacted with a pointing device such as a mouse or cursor may also be traced and stored by the user, a network or third-party service provider. User A 200 may explicitly post a status message to such sites indicating his or her current location or an intended destination or series of locations and associated times of expected presence (which could be remote in time.) User A may also send emails indicating the user's current location or intended destination as well as communicated interactively through speech or IM in real-time with other users such that all of these channels may be sources of data regarding user location or destination including weighting the reliability of specific data instances or values based upon entity extraction from communications before, during or after the location/time data seeking to be verified. The verified presence tracking service 100 could also provide means to allow a user to directly post a stated location for the service to use via, for example, a webpage or a text message.

Location data could be obtained from communications networks. In the illustrated example, User A 200 and User B 300 both have phones 220 and 320 connected to a mobile network such as a CDMA or GSM network. User A's Personal Data Assistant PDA 240 may also be connected to a wireless network The position of the user's devices 220, 240 and 320 could be determined or approximated using any conventional technique such as triangulation of cell signals or the location of the nearest cell tower. The user's devices 220, 240 and 320 could also include other sensors, such as GPS sensors which could provide a relatively precise geographical position as well as biometric or orientation-in-space data. Successive sets of data could be analyzed to determine a real-time rate and direction for any motion as well as to establish individual, archetype user and aggregated user patterns and trends, which becomes valuable data in weighting the reliability of future location data instances.

Location data could be obtained from sensor networks. In the illustrated example, User A 200 is within the sensing radius of one or more sensor 600. The sensors 600 could be any kind of sensor capable of identifying an individual with a reasonable degree of accuracy including but not limited to RFID tag readers, biometric sensors, motion sensors, temperature or weather sensors, access sensors, security sensors or multimedia stream sources including real-time feeds from on scene users with multimedia streaming or capture enabled devices, appliances, vehicles, buildings, etc. For example, the sensors 600 could be any kind of biometric sensors such as a facial recognition system or a fingerprint scanner. The sensors 600 could be scanning devices for user identification credentials, such as a drivers license. The sensors could be RFID sensors that sense RFID devices associated with a user through, for example, a user device such as a PDA 240 in which an RFID device is embedded. Other known RFID-imbedded devices include people, clothing, vehicles, jewelry and child or elderly protection or monitoring devices.

Location data for one user could be provided by another user. For example, A 200 user could similarly provide a stated location for another user. For example, User A 200 could post a status message to a website or send an email that indicates User B 300 is, or will be, in a specific place at a specific time. One user's device could recognize the presence of another user's device in a given location. For example, User A's PDA 240, could use a short range communication protocol such as the Bluetooth protocol, recognize that User B's phone 320 is within range of the PDA and transmit such information to the verified presence tracking service 100 through one or more networks 900. A user device could be used to request a user to explicitly verify the presence of another user in a given location. For example, the verified presence tracking service 100 could send an inquiry to User A 200 via a text message, an email or an instant messages requesting User A to verify that User B 300 is in a given location or co-present with one or more additionally specified users or objects.

Location data could also be provided through one or more third party location data providers 800. This may be necessary under circumstances where location data cannot be directly obtained from a communications or sensor network, such as foreign jurisdictions which strictly control location data for privacy or national security reasons. It may also be from local area sensor networks such as video feeds, local wifi or other presence or identity enabled processes, appliances or devices that sense and record users and/or their activities at one or more locations. For example, a theme park or access-controlled home owners association gather data on users and their locations, their comings and goings which may be offered in real-time or post-event to others on a free or fee-basis.

Thus location data can be obtained through a variety of sources. Such data may vary, however, widely in reliability and granularity. The reliability and granularity affect the uses to which location can be put. Some applications may have relatively permissive requirements. For example, if a user is curious as to where his or her friends are currently located or where they have traveled recently, it may be sufficient to know they are in, or have traveled through specific states, countries or cities, and it may not be particularly important if a significant portion of the data is inaccurate. By definition, a less granular picture of user location or path data has a lower reliability threshold, whereas a highly granular location or path request has a higher reliability based upon actual number of available sources of verifying location data corroboration data. Also, if location data is used for commercial purposes, such as confirming that a user went for a test drive at a particular car dealership or dined at a specific restaurant to satisfy the terms of an online coupon, location data needs to be very reliable and detailed enough to satisfy the requirements of the specific application. If location data is used for security purposes, such as locating a missing user, it must be of the highest possible reliability.

The reliability of location data depends broadly on the sources of the information and the circumstances under which the data is collected. One conceptual model for reliability of location data of a user could be stated as follows.

R₁=C_{L}(P₁S₁)
Where R₁ is the reliability of location data relating to User 1,
   C_{L} is the reliability of the context in which the data is collected,
   P₁ is the reliability of User 1 supplying location data
S1 is the reliability of the sensor associated with User 1 supplying location data

The term “context” should be understood to refer broadly to the total set of circumstances under which location data is obtained. It includes, without limitation, the physical location of the user and the sensor, the date and time the data is obtained, environmental factors, such as weather, co-presence of other users, devices or sensors/networks, metadata associated with any and all of those as well as data forecasting the activities the user is engaged in, such as watching concerts, attending school, shopping, and so forth. As stated above, entity extraction from communications and analysis off individual and system-wide user locations and sensor value correlation enable a rich ability to model any form of activity for which data can be sensed.

For the purposes of this application, where the term “reliability” is used, it is understood that unless otherwise qualified, it refers to the reliability of a user, sensor, place, time and so forth as a source of location data. It is not intended to imply that a user, sensor, place is reliable or unreliable in any other, or broader sense.

The conceptual model above expresses the general principal that when location data regarding a specific user is obtained, the reliability is affected by a combination of the reliability of the user as a source of information, the reliability of the sensor from which location data is received and the reliability of the context under which the location data is obtained. If any one of the three is unreliable, location data may be suspect.

In one embodiment, reliability of a given user, sensor or context may be determined on a typological basis, on an empirical basis or both. A user may be assigned to one or more types or archetypes based on any number of factors that describe the user. Such factors may include demographic factors such as age, nationality, gender, income, wealth, educational level and profession. Such factors may include the user's interests such as a favorite type of music, literature, hobby or other activities. Such factors may include metrics about the user's behavior on the Internet, such as the number of social networking websites the user is a member of, the number and frequency status messages posted by the user, the number of emails sent by a user, original content or content annotations published by the user, and so forth.

As a verified presence tracking service accumulates data, it may become obvious that certain types of users and/or devices are reliable sources of location data. For example, users between the age of 25-35 with graduate degrees who post status messages to social networking or microblogging services 10 times per day may be more reliable sources of location data because their regular supplying of explicit location data provides a more reliable path through space time of their actual locations than users who provide or create less explicit location data. On the other hand, users over the age of 55 who rarely or never send emails, instant messages or post status messages may be less reliable sources of information. In all cases, a users co-location with a device such as a cellular telephone or computing device that has a passive sensing capability enables a means to track their location implicitly without any need for status or location updates explicitly from the user.

When a user first becomes known to a verified presence tracking service, the user could be assigned a default reliability, or, alternatively, could be typed by one or more factors associated with that user and assigned an initial reliability based on such a type. For example, users who regularly shut off their devices or who have a history of post-event editing of their location data may be given a lower reliability score based upon their explicit attention to passive location data being gathered on them and/or an established pattern of falsifying or editing passively gathered location data. Reliability may also relate to the number and sophistication of sources. For example, a user with three co-present mobile devices gathering passive location data is far more reliable than a user with only one such device. Uses with GPS-enabled devices are more reliable than those with only cell-tower level location granularity.

After sufficient amount of verified presence data is accumulated regarding a user, it may be possible to determine the reliability of a user as a source of location data empirically, which is to say, on the basis of data alone. Thus, for example, a user who is typologically within a group that is generally considered to be reliable, may be found to be unreliable. For example, a user between the age of 25-35 with a graduate degrees who posts status messages to social networking or microblogging services 10 times may habitually post misinformation regarding his or her location or lend his or her mobile devices to other users.

A sensor may be assigned to one or types based on any number of factors that describe the sensor. Such factors may include basic types of technology, such as GPS sensors, RFID sensors, short range wireless sensors using protocols such as the Bluetooth protocol, or biometric sensors. Such factors may include the sensor's brand, or model number, or whether the device is running trusted client software or untrusted client software. When a sensor first becomes known to a verified presence tracking service, the sensor could be assigned a default reliability, or, alternatively, could be typed by one or more factors associated with that sensor and assigned an initial reliability based on such a type.

After sufficient amount of verified presence data is accumulated regarding a specific sensor, it may be possible to determine the reliability of the sensor as a source of location data empirically. Thus, for example, a sensor that is typologically within a group that is generally considered to be reliable may be found to be unreliable. For example, a GPS sensor may be considered to be generally reliable, but a given user's device may contain a GPS sensor that is defective or whose operation is impaired by the device in which it is embedded.

A context may be assigned to one or more types based on any number of factors that describe the context. Such factors may include a general description of the surroundings, such as, for such types could include example characterizations of the environment based upon density or number of sources of data, e.g. rural, suburban and urban environments. Within a given environment, there may further degrees of differentiation, such as residential, commercial, urban canyon, and highway environments including and up to exact location data. Such factors may include a type of building or location, such as, for example, shopping mall, auditorium, bar or club, office building or hospital environments. Such factors could include other environmental factors, such as co-present users or devices, weather and so forth,

A context may also be assigned to types using temporal factors, which could include, without limitation, a specific time of day, a general day division such as morning, afternoon and evening, a day of the week, a season of the year, a specific holiday, and so forth. A context may be assigned to types based on activities a user is engaged in which could include, without limitation, a concert, a sporting event, a class, dining, work or vacationing and so forth.

As a verified presence tracking service accumulates data, it may become obvious that certain types of contexts are more or less reliable sources of location data. For example, a context such as a user at work in a suburban environment on Wednesday afternoon may be a relatively reliable context. A context such as an urban canyon at rush hour on Friday in bad weather may be less reliable. A context such as a concert on a Saturday night may be even less reliable.

It is worth noting that the reliability of a user, sensor or context may exhibit temporal patterns of reliability. For example, a context relating to an urban canyon may be unreliable between 7 and 10 AM on weekdays, relatively reliable between 10 AM and 4 PM, unreliable between 5 and 7 PM on weekdays and very reliable on weekends. Such temporal patterns of reliability could be used to empirically type a user, sensor or context that has not been typed.

For example, suppose a given location, such as building, street, block or neighborhood is known to be within a city, but nothing else is known. If the reliability of location data is found to be unreliable between 7 and 10 PM and reliable between 10 AM and 4 PM on weekdays, it could be inferred that the location is in an urban canyon context. This can valuable if, for example, there is little data regarding the reliability of location data obtained from the area on weekends.

This example also demonstrates how reliability of a user, sensor or context could be determined using a combination of typological and empirical reliability where the reliability of the user, sensor or context varies temporally. In one embodiment, if sufficient data can be obtained to determine reliability of a given user, place or context during specific time periods, actual data will be the preferred method of determining reliability of the user, place or context, but during time periods having little or no actual data, reliability could be determined typologically.

As discussed above, types of contexts can exhibit significant temporal variations in reliability. Types of user and sensors may, however, also exhibit significant temporal variations in reliability. For example, mobile devices which utilize a mobile network that is prone to instability during peak load hours may exhibit significant temporal variations in reliability regardless of location. A user between the ages of 21-25 may become unreliable sources of information on Friday night after 8:00 PM regardless of location.

Location data relating to a user can, in certain cases, be obtained from a second user. For example, suppose a first and second user are at the same location. Suppose both devices support a short range wirless protocol such as Bluetooth. Suppose further that the second user's mobile device has a GPS sensor. The Bluetooth protocol sensor of the second user's mobile device could detect the presence of the first user's mobile device. The second user's mobile device could then associate the first user with the location provided by the GPS sensor of the device. Alternatively, or additionally, the second user could post a status message to a social networking site indicating the first user is in a specific location.

In such a case, one embodiment of a conceptual model for the reliability of location data could be stated as

R₁=C_{L}(P₁S₁→P₂S₂)
Where R₁ is the reliability of location data relating to User 1,
   C_{L} is the reliability of the context in which the data is collected,
   P₁ is the reliability of User 1 supplying location data
   S1 is the reliability of the sensor associated with User 1 supplying location data
   P₂ is the reliability of User 1 supplying location data
   S₂ is the reliability of the sensor associated with User 1 supplying location data

Thus, the reliability of location data obtained from a second user regarding a first user can be a function of the reliability of both users and both sensors, as well as the context in which location data is obtained. This particular type of situation is noteworthy because location data obtained regarding a very unreliable source may be more reliable if it is obtained via a very reliable source.

The reliability of location data, in general can be verified in variety of ways. Three general categories of methods of verification are corroboration, currency and consistency. Location data is corroborated when essentially the same data is obtained regarding a location at a specific time from multiple sensors. Thus, for example, a user may have a cellular phone, a second mobile device having a GPS and may frequently post status messages to a microblogging site. Location data could be obtained from all three sources and compared. If all three sources agree more than some fixed percentage of the time, for example, 95%, location data from all three sources could be considered very reliable. If on the other hand, status messages rarely agree with GPS and cellular location data, then status messages could be considered unreliable, but if GPS and cellular location data are relatively similar, they may still be considered reliable sources of location data. If no source agree with one another, they could all be considered unreliable sources of location data.

Corroborating location data from reliable sources which are not under the control a user are an especially valuable source of corroboration. For example, if a user is identified in a public location by a public biometric sensor, it is strong, if not definitive, corroboration or refutation of location data obtained from the user's GPS device that places the user in the same location or a different location respectively. In another example, if a first user's mobile device is detected by a second user's mobile device, and the second user's mobile device has a reliable GPS device, location data from the second user's mobile device that places the first user in the same location as data from the first user's mobile device strongly corroborates the location data from the first user's device. Social status messages posted by a first user that places a second user in a location that agrees with location data obtained from sensors associated with a second user corroborates such data.

In the case of location data collected from a sensor in a user device, the data can be further corroborated if there is evidence that the user was actually with his sensing device at the time the location data was collected. For example, a user recently authenticating (e.g. providing login credentials) via his sensing device provides evidence that the user was actually with his device and can temporarily increase the confidence score for location data provided by that devicee. A user device that collects a user voice print when making a phone call at or near the time location data was collected can be corroborating data.

The reliability of location data can also be explicitly corroborated by a third party. In one embodiment, the reliability of the retrieved location data is based upon the certification of a sensor by a trusted source. In one embodiment, the reliability of the retrieved location data is based upon the certification of data obtained from a sensor by a trusted source.

The reliability of location data can be inferred from currency. Time elapsed between sensor input and a presence request will generally decrease confidence in a location. For example, a GPS upload from 7:30 PM will provide more evidence that a user was at a given location at 7:35 PM than will a GPS reading from 8:00 PM. Time between sensor data acquisition and data upload will also decrease confidence (increasing the likelihood of tampering with the data. For example, a GPS reading that was uploaded immediately is more likely to be reliable than a reading contained in a GPS log that was uploaded a week after the fact. In another example, a social status message recorded on Tuesday that identifies the location of a user the previous Saturday may be suspect.

The reliability of location data can be inferred from consistency. In one embodiment, Location data can be considered to be consistent if, on the whole, it exhibits temporal patterns of variation that are within expected patterns of behavior. Data that lays outside of such patterns of behavior may be considered as unreliable. For example, suppose a user typically commutes between San Jose and San Francisco most weekdays. If a user's location data places the user in San Francisco on Monday and Wednesday, and in the Philippines on Tuesday, the user's location data relating to the Philippines is suspect.

Note that the reliability of location data may vary by granularity of the location information. For example, location data based on the nearest cell tower to a cell phone may be extremely reliable as a source of data indicating the position of a user's cell phone at the level of a state or city, but be very unreliable in locating the street or building a user is in.

In one embodiment, a verified presence tracking system can continuously track and store location data relating to a large number of users and sensors and associate such data with one or more contexts having one or more context properties. Such data can be continuously analyzed to determine the reliability of users, sensors and contexts, both on an individual and typological level. Over time the presence tracking system will learn reliability scores for various sensors.

Those sensors that frequently provide data consistent with other sensors will be considered more reliable (leading to higher confidence scores associated with readings from those devices) while sensors that provide inconsistent results will have their reliability reduced. The notion of reliability can be propagated through users as well. Data from a user who owns a sensor that provides bad data will initially have low confidence while a new device from a reliable user will initially have higher reliability scores.

In one embodiment, a verified presence tracking service could collect additional data regarding users in additional to spatial and temporal data. For example, the service could collect social and topical data relating to users. For example, the system could mine social networking sites or user blogs to identify a given user's friends, profession, interests and hobbies. In one embodiment, the lives of users can be instrumented and referencing and cross-referencing data associated among users known to the system can be used to create and maintain a global presence graph that has the path and last known/current location in real-space mapped together relative for all known users. Within a global presence graph, a location can be a physical geographic coordinates or labels applied to bounded areas of space, but since this graph can also link to all related data, users can also be located in many virtual locations based upon online resources and/or topics/content sub-categories.

In one embodiment, a global presence graph can be used to compute actual and relative distances between users and location-reporting sensors. For example, a coffee shop with ten patrons may include 8 with 12 devices that are known to a verified presence tracking service, so its global graph maps these users, devices and sensors as co-present within a bounded physical location. A similar number of people may occupy a similar density at another location and not represent a bounded set, e.g. at a park where a large concert or festival is ongoing. A global presence graph can be used for scoring the reliability of location data based upon the availability or non-availability of a corroborating data source, and the graph can be used as the basis for selection and ranking of potential verification sources.

A verified presence tracking service can thus provide a large collection of location data related to a large number of users. Such location data has myriad applications. One type of application is a real time location request. In one type of location request, a first user may request the current location of a second user. In another type of location request, a first user could request verification that a second user is currently in a particular location. Such a request could be preferred in some cases, since it is less intrusive. For example, a user may only be allowed to listen to a set of music tracks if he or she is in a particular business location, but the business does not need to know the user's actual location if the user is not currently in the business.

In one embodiment, location request can also request historical location data. For example, a first user may request the location of a second user at a particular time, or through one or more ranges of times. In another example, a first user could request verification that a second user was in a particular location at a specific time of range of times. In another example, a first user could request verification that a second user was in a series of locations, either in a particular time order, or randomly. In general, a historical location verification request could specify a pattern of locations, some of which could be optional or required, and which could specify exact times or time ranges.

In any of the above embodiments, such location requests could specify a granularity (e.g. city, street, building or business, or, alternatively, a one mile radius, a four block radius or a ten foot radius.) Such could also specify a confidence, such as, for example, at least 50% likely the location is correct, at least 90% the location is correct, or near certainty (within the limits of the system) the location is correct.

A user's current or historical location information is potentially sensitive. While some users may be indifferent as to whether their location data is known to the general public, many, if not most users would prefer to restrict access to their location data to a limited set of users. A location tracking service could, in theory, be based on publically available information, but is greatly enhanced if private or semiprivate data is gathered from user owned sensors and other sources. Such data may be very sensitive. In fact, a user may have serious safety concerns that they may be stalked or harassed by hostile individuals or organizations if their current and historical location data becomes publically available.

In one embodiment, a verified presence tracking service only tracks private or semiprivate location data for users who have explicitly become members of such a service. Such a service could, optionally, also include publically available location information for user and non-users of the service. In one embodiment, a verified presence tracking service can enable a user to set up preferences and access permissions that specify who should have access to the user's location data. Access rights can be set up as a white list or black list that specifies classes of other users, or individual users who are allowed or barred respectively from viewing another user's location data.

Access rights can define the granularity of location data that a user or class of users can access. For example, a user may allow all users to view the user's stated location, which as noted above, may or may not correspond to the users actual location. A user may allow coworkers or family members to determine what country, state or city the user is located in, but not an actual street or business. A user may allow close friends the user has defined to the verified presence tracking service to view the user's real time location, but not the user's location history. A user may allow a vendor to verify the user's location history to qualify the user for an online promotion, but prohibit the vendor from view any location data related to the user.

In one embodiment, a location request input to a verified presence tracking system can be given access to a user's location history based on a multifactor rating given to the request based on source and purpose. Such a rating can be based on the source of the request and the purpose of the request. For example, requests from spouses or family members can be rated higher than from friends, which can be rated higher than acquaintances, which can in turn be rated higher than from total strangers. Degrees of relationship between the users and acquaintances or strangers may also allow the useful classification and rating of sub-groups of users based upon the frequency, duration, number and quality of contacts or data associations between the requester and the subject of the request.

The purpose of a request may or may not be stated, so a default non-modified purpose can be assumed, while a user can create a list of prioritized purposes, processes or users whose requests are rated highly. For example, requests defined as “urgent” or “emergency” could be rated higher that requests defined as “work related” which could be rated higher that requests defined as “social contact” which could in turn be rated higher that “promotion verification.”

The rating of a request can in turn define whether the request is processed or rejected. For example, an “emergency” request from a family member would likely be processed, whereas a “social contact” request from a stranger or acquaintance might be rejected. In one embodiment, the rating of a request could determine the granularity of location data made available to a requestor. For example, a high rated request could be allowed to provide location data that can locate a user within a building or a small physical radius, such as 50 feet. A low rated request might only be given location data at a country, state or city level, or may only have access to a user's stated location.

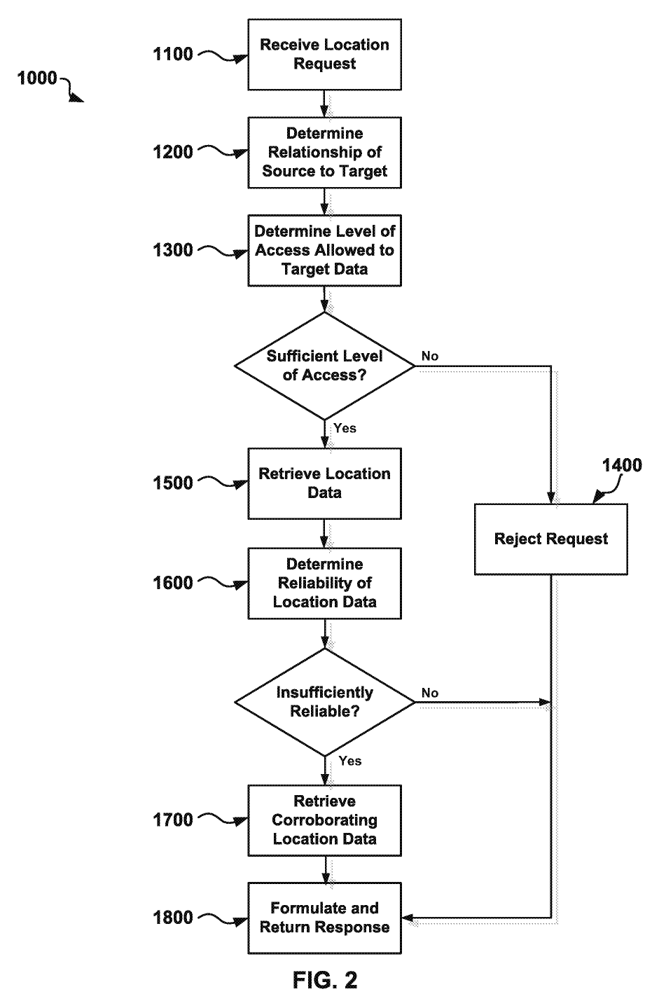

FIG. 2 illustrates one embodiment of a process 1000 for verified presence tracking using at least one embodiment of the system disclosed herein.

A request for a location is received 1100, over a network, such as the Internet. The request may have been transmitted from a user, an organization or a system using any conventional methodology for transmitting information over a network, such as data entered through a web form, transmitted using a custom API, an email, or an instant message. In one embodiment, the request comprises a request type, a request source and a request target. In one embodiment, the request may additionally comprise one or more request parameters.

In one embodiment, the request types can include a request type for a target's location and a request type to verify a target's location. The request source could comprise an identification of an individual user (i.e. a user), an identification of a business entity, such as a product manufacturer or distributor, or an identification of any other type of entity having an interest in location data such as a law enforcement or security agency. The source could comprise an identification of another system, such as, for example, an advertising revenue system.

The request target could comprise an identification of an individual user (i.e. a user), although the target could be any kind of object or entity that can be associated with locational data. For example, such an entity could be a corporate resource used by many users, such as a company cell phone or laptop. Such an entity could be a group of individual users. The request target could also comprise an identification of a group of two or more individuals. Where the request type of a multiple target location request is a location request, the request is essentially equivalent to two or more separate location requests. Where the request type of a multiple target location request is a location verification request, all specified targets must satisfy the terms of the request

The request parameters can include a variety of options depending on the request type, source and target. In the case of a request type to verify a target's location, the request parameter can include one or more spatial parameters that comprise an identification of a location or list of locations. The identification of the location could be in any format necessary to express the location at a level of granularity required by the request, such as a state, city, a building or a business location.

Request parameters can include one or more temporal parameters that specify a time or time range or a list of times or time ranges for a location request. A temporal request parameter could specify a real-time request, or a request for the most recent known location for a target. A temporal request parameter could specify a historical date and time, a range of historical dates and times or a list of such dates and times. A temporal request parameter could specify a time or date offset, a holiday or an event or any other data that can be resolved to an absolute date and time or date and time range.

In the case of a request type to verify a target's location where the request parameter include spatial parameters that comprise an identification of a list of locations, each location in the list of locations can be associated with one or more temporal request parameters. Note that a list of locations with times can, together, define a pattern of behavior that can be used for many purposes. For example, such a pattern could be used to verify a user's participation in a promotion. Such a pattern could also be used to identify abnormal patterns of behavior, e.g. a pattern that indicates a person may have been abducted.

In one embodiment a request to verify a target's location could includes at least one additional user where the purpose of the request is to verify that the target and the additional users are or were co-located. Such a request could additionally include at a specific location and time or a list of locations and times.

Request parameters can include one or more parameters that define the purpose of the request. In one embodiment, users can create list of prioritized purposes, processes or users whose requests are rated highly. For example, requests defined as “urgent” or “emergency” could be rated higher that requests defined as “work related” which could be rated higher that requests defined as “social contact” which could in turn be rated higher that “promotion verification.”

Request parameters can include one or more parameters explicitly indicating the granularity required for the request. For example, the request could specify a parameter requesting location data at a country, state, city, street, a business or building or an exact GPS location. The granularity stated in the request could be a preferred granularity, or a required granularity. The granularity of the request may be implied based on other parameters. For example, an “emergency” request could imply the highest level of granularity available. The required granularity could be implied in a location verification request by the level of granularity of the requested location (e.g. state, city or building.)

Request parameters can include one or more parameters explicitly indicating the reliability of data required for the request. For example, the request could specify a parameter requesting location data that where there is a 90% confidence the data is correct. The reliability stated in the request could be a preferred reliability, or a required reliability. The reliability of the request may be implied based on other parameters. For example, an “emergency” request could imply the highest level of reliability available. The required reliability could be implied in a location verification request by the level of granularity of the requested location, where, for example, a request for data at a state or city level need not be retrieve location data that is as reliable as that needed for a request at a building level.

All request parameter could additionally be assigned default values if they are not explicitly entered. For example, a default temporal parameter could be the current date and time (i.e. real-time), a default purpose could be “inquiry.” A default granularity could “best available” where the best available granularity reflects the most detailed data the source is allowed to access (and not necessarily the most detailed data available on the system.) A default reliability could be “best available” representing the most reliable data (which may not be very reliable in some cases) that is currently known to a location verification system.

The relationship of the request source to the request target is then determined 1200. In one embodiment, the source and the target are members of a verified presence tracking service and the relationship between the source and the target is known to the service. In one embodiment, the relationships between the target and the source could include, without limitation, “spouse”, “parent”, “child”, “employer”, “employee”, “agent”, “client”, “self”, “friend”, “relative”, “acquaintance”, “coworker”, “vendor” or “advertiser” or “sponsor.” In one embodiment, users explicitly define their relationships with other users. In one embodiment, the relationships between users is automatically mapped by analyzing available data sources such as user emails, user BLOGs, user social network profiles and user status messages. In one embodiment, the relationship between the source and the target can be verified by the target before a request is processed. The relationship could be verified by the user in real-time via, for example, emails, instant messages or any other medium that can enable a user to respond to an inquiry. In one embodiment, the relationship between the source and the target can be automatically verified by a device associated with the target.

The level of access the source is allowed to the target's location data is then determined 1300. In one embodiment, the target has defined access privileges on a verified presence tracking services. In one embodiment, access privileges are defined for types of relationships such as “friend”, “coworker” and “stranger”, and can additionally be defined for specific users or groups of users. In one embodiment, access privileges specify the level of granularity of location data a user to which a user has access. In one embodiment, lists of users, groups of users or relationships could be placed on a whitelist that have defined access rights to a user's location data, and all other users have no access rights. In one embodiment, lists of users or groups of users could be placed on a blacklist such that such users are denied access rights or given reduced access rights even if the relationship of the source to the target would ordinarily imply access to the target's location data.

In one embodiment, requests could be rated using a multifactor rating given to the request based on source and purpose. For example, requests from spouses or family members can be rated higher than from friends, which can be rated higher than acquaintances, which can in turn be rated higher than from total strangers. Requests defined as “urgent” or “emergency” could be rated higher that requests defined as “work related” which could be rated higher that requests defined as “social contact” which could in turn be rated higher that “promotion verification.”

In one embodiment, the rating of a request be used to determine whether a request is processed at all, and what granularity of location data the to which the source will be allowed access. For example, a high rated request could be allowed to provide location data that can locate a user within a building or a small physical radius, such as 50 feet. A low rated request might only be given location data at a country, state or city level, or may only have access to a user's stated location or may be allowed no access whatsoever to a target's location data.

In one embodiment, access privileges could be defined separately for location requests and location verification requests. As discussed above, a location verification request is potentially less intrusive than a location request, since if a target is not or was not at a specified location at a specified time, the source will not be given the target's location. In one embodiment, access privileges could be defined separately for real-time and historical location data requests. As discussed above, a real-time location request is potentially less intrusive than a historical location request since a real-time request only reveals a current location, whereas a historical request can provide a detailed plot of a user's activities over time.

If the source does not have sufficient access permission to access the target's location data at the request's required level of granularity, the request is rejected 1400. As discussed above, every request will be associated with an explicit, implied or default required granularity. Many requests may simply be for “best available” location data, which is the most detailed level of location data to which the source has access. If a specified granularity of a request is a preferred granularity and the source does not have access to location data for a target at that level of detail, the target receives can receive data at a “best available” level, and can thus be processed.

In at least one embodiment, steps 1200 through 1400 as described above are optional. In one embodiment, all users of the service are authorized to view location data for all other users. In one embodiment, a user of the service is only authorized to view location data for a target when the target expressly consents to allow the user to view the target's location data.

Location data related to the request is then retrieved 1500 from one or more location data sources. In one embodiment, location data is retrieved from one or more databases of location data maintained by a verified presence service that retrieves location data from sensor networks, communication networks and other location data sources. In one embodiment, the verified presence tracking service collects additional data regarding users in additional to spatial and temporal data and references and cross-references data associated among users known to the system to create a global presence graph that has the path and last known/current locations in real-space mapped together relative for all known users. In one embodiment, the global presence graph can be used to retrieve location data relating to a target.

Alternatively, in one embodiment, real-time location data could be retrieved from a network of sensors from sensor networks, communication networks and other location data sources in real-time. In one embodiment, real-time location data and data retrieved from one or more databases could be combined. In one embodiment, real-time and historical location data could be retrieved from a third-party location data source.

The reliability of the retrieved location data is then determined 1600. In one embodiment, for each location data point, the reliability of the users and the sensors involved in collecting the data is identified and the reliability of the context under which the data was collected is identified. In one embodiment, the reliability of users, sensors and contexts can be determined empirically or typologically, and may vary temporally.

In one embodiment, location data can be further evaluated for corroboration, consistency, and currency as discussed in detail above. In one embodiment, a global presence graph maintained by a verified presence tracking system can be used to identify corroborating data, evaluate the consistency of location data for users over time and determine the currency of location data.

In one embodiment, the reliability of location data is determined when a location request is received. In one embodiment, the reliability of location data collected and stored by a verified presence tracking system is continuously determined at or near the time the data is collected.

If the reliability of the location data is insufficient to satisfy the terms of the request, additional corroborating data is retrieved 1700.

In one embodiment, a verified presence tracking service may not continuously retrieve location data from all possible sources. This may be for a variety of reasons. For example, a given sensor, such as a biometric sensor, may not be able to continuously recognize every user that comes within range of the sensor. This may be because of, without limitation, processing limits inherent in the sensor or bandwidths limit within the network to which the sensor is connected. Certain corroborating data sources might have a high cost of data acquisition such as, for example, sources for data acquisition that requires the efforts of another user to collect.

In one embodiment, a verified presence tracking service acquires data from a hierarchy of sensors, where location data is continuously acquired from a first group of sensors that have a low cost of data acquisition, such as, for example, data automatically acquired directly from GPS sensors associated with a user device or mobile phone location data acquired from a mobile network. Where a location request requires a higher level of reliability than is provided by data collected from the first group of sensors, data may be acquired from one or sensors in a second group of sensors that are used for obtaining corroborating data.

Sensors within the second group could comprise fixed sensors, such as biometric sensors, cameras, microphones, RFID tracking sensors and so forth, that data from which data can be automatically acquired. Sensors within the second group could also comprise mobile sensors associated with a user known to the system. Such sensors could include, without limitation mobile devices carried by a user such as mobile phones, PDA, cameras, voice recorders, and so forth. Acquisition of data from mobile sensors could be entirely automatic. For example, if it is desired to verify the location of a first user who has a mobile phone that supports a short range wireless protocol, the location of the first user's mobile phone could be verified by requesting a second user's mobile phone that supports the same short range wireless protocol to attempt to locate the first user's mobile phone.

In some cases, acquisition of corroborating location data could involve steps requiring a user to take a specific action. For example, if a verified presence tracking service has reason to believe that a first user whose location is to be verified may be within the visual range of a second user, the service could send a message to a mobile device associated with the second user asking the second user if he or she can see the first user. Such a message could be communicated in any manner suited to the second user's mobile device, such as a text message or email to which the second user can reply. The verified presence tracking service could also request the second user to take some other action that would provide data suitable to verify the first user's location, such as taking a picture of the first user or taking a voice recording of or near the first user.

In one embodiment, a global presence graph maintained by a verified presence tracking services comprises the last known location of all users, sensors associated with such users, and the location of all fixed sensors known to the service. In one embodiment, a global presence graph can be used to compute actual and relative distances between users and location-reporting sensors. For example, a coffee shop with ten patrons may include 8 with 12 devices that are known to the service, so its global graph maps these users, devices and sensors as co-present within a bounded physical location.

In one embodiment, the verified presence service rates the reliability of all sensors known to the service. In one embodiment, when a verified presence tracking service is attempting to obtain corroborating data for the location of a user, the service can select one or more sensors based on the sensor's proximity to the location which is to be verified and the reliability of the sensor.

In one embodiment, if a first user or a first user's device supplies corroborating location data for a second user, the first user can be rewarded for consistent and reliable responses to such requests or reduced in reputation or reliability rating for failing to respond or for reports that later are proved likely to have been false (or fraudulent.) In some embodiments, verification sources may be monetarily compensated while in others received points, scoring, or increases to a reputation or reliability rating.

A response is then formulated and transmitted to the request source 1800. The content of the response will depend on the type of the request. A request for a location will return a description of a location. In one embodiment, the description of the location can be at the requested level of granularity if the source is permitted to view location data at that level of granularity and such data is available. If a source is not permitted to view data at that level of granularity, the location data description can provide a location description at the level of granularity the source is permitted to view. If location data is not available at the requested (or default) level of granularity, the location data can be provided at the best available level of granularity. The response can additionally include a reliability or confidence score for the location data. If more that more location is displayed, or if a location is displayed for a time range as a series of time slices, confidence or reliability scores can be displayed for each location or time slice.

A request to verify a location can return a simple “verified” or “not verified.” Alternatively, more information can be provided such as “no information available” or “information indicates target was in another location.” The verification message could also contain a confidence score that the target is or was in a location at a specific time.

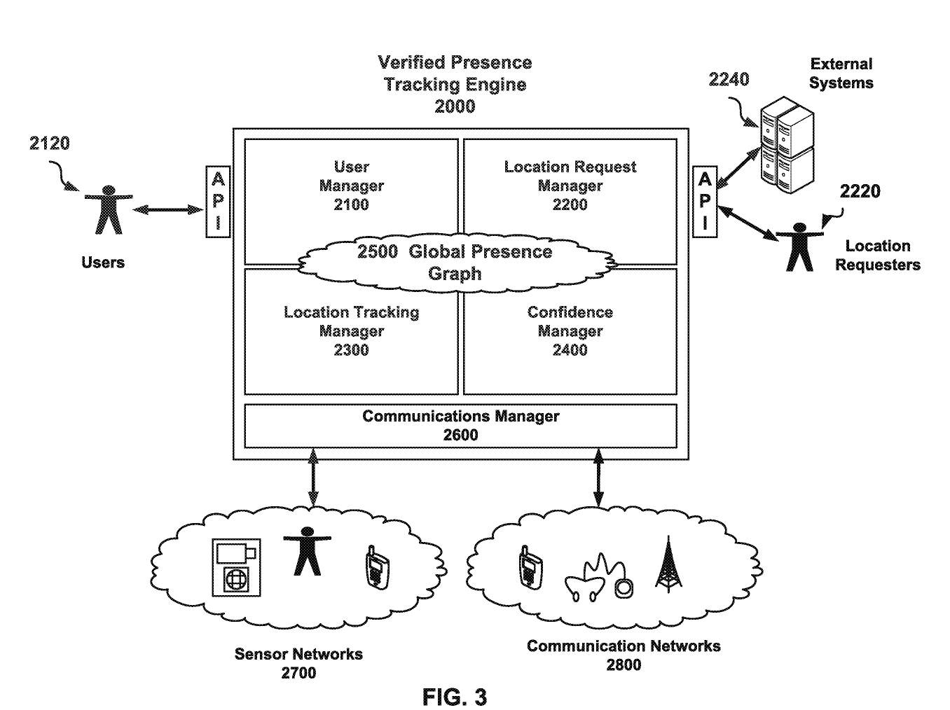

FIG. 3 illustrates one embodiment of a verified presence tracking engine 2000 capable of supporting at least one embodiment of the process described in FIG. 2 above. In one embodiment, the verified presence tracking engine 2000 comprises a User Manager 2100, a Location Request Manager 2200, a Location Tracking Manager 2300, a Confidence Manager 2400 and a Communications Manager 2600. In one embodiment, the verified presence tracking engine 2000 is hosted on one or more servers hosted by a verified presence tracking service such as the service 100 shown in FIG. 1.

In one embodiment, each of the managers comprises one or more processors programmed to execute software code retrieved from a computer readable storage medium storing software for functions as described below. In one embodiment, each of the modules could be hosted on one or more servers hosted by a verified presence tracking service such as the service 100 shown in FIG. 1. Such an embodiment is purely exemplary, and all of the managers shown could be implemented in any combination on any number servers, as will be readily apparent to those skilled in the art.

In one embodiment, the User Manager 2100 provides facilities that enable users or other entities, such as business organizations, to become users 2120 of the system. The User Manager 2100 can allow users to set up user profiles that can include user demographic information and preferences, define user devices that can serve as sources of location data for the user, and third party websites, such as social networking sites and microblogging sites, that can serve as additional sources of data relating to the user and the user's location. In one embodiment, the User Manager 2100 can provide a web enabled interface to users, such as a website comprising one or more HTML pages. In one embodiment, the User Manager 2100 can provide an API that enables software running on user devices to access facilities provided by the User Manager.

In one embodiment, the User Manager 2100 can provide facilities that enable a user to define the user's contacts and the users relationships to such contacts. Such relationships could include categories such as “friend”, “relative”, “acquaintance”, “coworker”, “vendor” or “advertiser.” In one embodiment, the User Manager 2100 automatically identifies a user's contacts and categorizes the user's relationships with such contacts by analyzing available data sources such as user emails, user BLOGs, user social network profiles and user status messages.

In one embodiment, the User Manager 2100 can provide facilities that enable a user to define access privileges to the user's location data. Access privileges could be defined for the user's contacts individually, or could be defined by categories of relationships. In one embodiment, access privileges specify the level of granularity of location data a user to which a user has access.

In one embodiment, lists of users, groups of users or relationships could be placed on a whitelist that have defined access rights to a user's location data, and all other users have no access rights. In one embodiment, lists of users or groups of users could be placed on a blacklist such that such users are denied access rights or given reduced access rights even if the relationship of the source to the target would ordinarily imply access to the target's location data.

In one embodiment, access privileges could be defined separately for location requests and location verification requests. In one embodiment, access privileges could be defined separately for real-time and historical location data requests

In one embodiment, the Location Request Manager 2200 can provide facilities to receive and respond to requests for location data and location verification from location requesters 2220 and external systems 2240 that have an interest in location data. In one embodiment, the Location Request Manager is configured to receive location requests comprising a request type, a request source, a request target and, optionally, one request or more request parameters. In one embodiment, the Location Request Manager 2200 can provide a web enabled interface to users, such as a website comprising one or more HTML pages. In one embodiment, the Location Request Manager 2200 can provide an API that enables software running on user devices to access facilities provided by the Location Request Manager.

In one embodiment, the request types can include a request type for a target's location and a request type to verify a target's location. The request source could comprise an identification of a individual user (i.e. a user), an identification of a business entity, such as a product manufacturer or distributor, or an identification of any other type of entity having an interest in location data such as a law enforcement or security agency. The source could comprise an identification of another system, such as, for example, an advertising revenue system.

The request target could comprise an identification of an individual user (i.e. a user), although the target could be any kind of object or entity that can be associated with locational data. For example, such an entity could be a corporate resource used by many users, such as a company cell phone or laptop. Such an entity could be a group of individual users. The request target could also comprise an identification of a group of two or more individuals. Where the request type of a multiple target location request is a location request, the request is essentially equivalent to two or more separate location requests. Where the request type of a multiple target location request is a location verification request, all specified targets must satisfy the terms of the request

The request parameters can include a variety of options depending on the request type, source and target. Such parameters could include: spatial parameters that comprise an identification of a location or list of locations, temporal parameters that specify a time or time range or a list of times or time ranges, parameters that define the purpose of the request, parameters explicitly indicating the granularity required for the request and parameters explicitly indicating the reliability of data required for the request. Such parameters are discussed in detail above in the description of process step 1 100. All request parameter could additionally be assigned default values if they are not explicitly entered.

In one embodiment, the Location Request Manager 2200 is further configured to determine, for each location request, the relationship between the source and the target using relationships defined and maintained by the target user using facilities provided by the User Manager 2100. Where no defined relationship exists, a default relationship such as “stranger” or “unknown” could be used.

In one embodiment, the Location Request Manager 2200 is further configured to determine the level of access a source is allowed to a target's location data using access privileges defined by the target user through facilities provided by the User Manager 2100. In one embodiment, requests could be rated using a multifactor rating given to the request based on source and purpose as discussed in detail above, and the level of access allowed to the source the level of access a source is allowed to a target's location data is determined using the rating. If the source of a location request does not have sufficient access authority to access the target's location data at the request's required level of granularity, the request the Location Request Manager 2200 rejects the request and can further send a rejection message to the request source.

In one embodiment, if the source of a location request has sufficient access authority to access the target's location data at the request's required level of granularity, the Location Request Manager 2200 requests the target's location data from the Location Tracking Manager 2300 at a required level of reliability. In one embodiment, the Location Request Manager 2200 receives location data and location reliability data from the Location Tracking Manager 2300 relating to location tracking requests and formulates and transmits responses to such location tracking requests to the requesting sources.

The content of the response will depend on the type of the request. A request for a location will return a description of a location. In one embodiment, the description of the location can be at the requested level of granularity if the source is permitted to view location data at that level of granularity and such data is available. If a source is not permitted to view data at that level of granularity, the location data description can provide a location description at the level of granularity the source is permitted to view. If location data is not available at the requested (or default) level of granularity, the location data can be provided at the best available level of granularity. The response can additionally include a reliability or confidence score for the location data. If more than one location is displayed, or if a location is displayed for a time range as a series of time slices, confidence or reliability scores can be displayed for each location or time slice.

Location Request Manager 2200 can return a can return a simple “verified” or “not verified” response to a request to verify a location. Alternatively, more information can be provided such as “no information available” or “information indicates target was in another location.” The verification message could also contain a confidence score that the target is or was in a location at a specific time.

In one embodiment, communications between the Location Request Manager 2200 and requesting users can be encrypted at an appropriate level of encryption based on the source and the targets security needs. In one embodiment, communications between the Location Request Manager 2200 and requesting users can be conducted on a secure channel.

In one embodiment, the Location Tracking Manager 2300 continuously or periodically retrieves location data relating to users registered through the User Manager 2100 from one or more location data sources using the facilities of the Communications Manager 2600. Such location sources sensor networks 2700, communication networks 2800 and other location data sources such as third party location data providers. In one embodiment, the Location Tracking Manager 2300 stores retrieved location data on one or more databases. In one embodiment, the verified presence tracking service collects additional data regarding users in addition to spatial and temporal data and references and cross-references data associated among users known to the system to create a global presence graph that has the path and last known/current locations in real-space mapped together relative for all known users.

In one embodiment, the Location Tracking Manager 2300 responds to requests from the Location Request Manager 2200 for location data relating to target users and returns the location data along with reliability scores for the data to the Location Request Manager 2200. In one embodiment, the Location Tracking Manager 2300 retrieves location data from one or more databases of location data maintained by the Location Tracking Manager 2300. In one embodiment, a global presence graph maintained by the Location Tracking Manager 2300 can be used to retrieve location data relating to a target.

Alternatively, in one embodiment, real-time location data could be retrieved in real-time from a network of sensors from sensor networks, communication networks and other location data sources using the facilities of the Communications Manager 2600. In one embodiment, real-time location data and data retrieved from one or more databases could be combined. In one embodiment, real-time and historical location data could be retrieved from a third-party location data source.

In one embodiment, the Location Tracking Manager 2300 requests reliability scores from the Confidence Manager 2400 for specific location data when it is responding to a request from the Location Request Manager 2200 for location data relating a target user. In one embodiment, the reliability of the location data retrieved by the Location Tracking Manager 2300 is continuously evaluated by the Confidence Manager 2400 and reliability scores can be stored in a database accessible to the Location Tracking Manager 2300 or the Confidence Manager 2400 or both. In one embodiment, reliability scores are stored along with location data in a global presence graph 2500 maintained by the Location Tracking Manager 2300.

In one embodiment, the Confidence Manager 2400 assigns reliability scores to data retrieved by the Location Tracking Manager 2300. In one embodiment, the Confidence Manager 2400 scores the reliability of data retrieved by the Location Tracking Manager 2300 only when specifically requested to do so by the Location Tracking Manager. In one embodiment, the reliability of the location data retrieved by the Location Tracking Manager 2300 is continuously evaluated by the Confidence Manager 2400 at or near the time the data is collected.

In one embodiment, the Confidence Manager 2400 determines the reliability of the users and the sensors involved in collecting location data and further determines the reliability of the context under which location data was collected. In one embodiment, the reliability of users, sensors and contexts can be determined empirically or typologically, and may vary temporally.

In one embodiment, the Confidence Manager 2400 can enable a system level user to manually define the reliability of types of users, types, and contexts where empirical reliability data is not available. Users, sensors and contexts representing types unknown to the Confidence Manager 2400 can be assigned a default reliability. In one embodiment, the Confidence Manager 2400 is configured to continuously or periodically evaluate the reliability of users, sensors and contexts and types of users, sensors and contexts using location data retrieved by the Location Tracking Manager 2300.

In one embodiment, Confidence Manager 2400 empirically determines the reliability of location data retrieved by the Location Tracking Manager 2300 by evaluating the data for corroboration, consistency, and currency as discussed in detail above. In one embodiment, a global presence graph maintained by a verified presence tracking system can be used to identify corroborating data, evaluate the consistency of location data for users over time and determine the currency of location data.

In one embodiment, when the Location Tracking Manager 2300 requests reliability scores from the Confidence Manager 2400 relating to location data, the Location Tracking Manager 2300 can additionally specify a preferred or required level of reliability for the data. If the Confidence Manager 2400 determines the reliability of the location data is insufficient to satisfy the terms of the request, Confidence Manager 2400 can attempts to retrieve additional corroborating data using facilities provided by the Communications Manager 2500.

In one embodiment, the Confidence Manager 2400 can attempt to retrieve, additional corroborating data from sources not normally used by the Location Tracking Manager 2300. Such sources could include fixed sensors, such as biometric sensors, cameras, microphones, RFID tracking sensors and so forth, that data from which data can be automatically acquired. Such sources could also include mobile sensors associated with a user known to the system. Such sensors could include, without limitation mobile devices carried by a user such as mobile phones, PDA, cameras, voice recorders, and so forth.

The Confidence Manager 2400 could acquire data from mobile sensors automatically. For example, if it is desired to verify the location of a first user who has a mobile phone that supports a short range wireless protocol, the location of the first user's mobile phone could be verified by requesting a second user's mobile phone that supports the same short range wireless protocol to attempt to locate the first user's mobile phone.

The Confidence Manager 2400 could acquire corroborating location data using facilities provided by the Communications Manager 2500 involving steps requiring a user to take a specific action. For example, if the Confidence Manager 2400 has reason to believe that a first user whose location is to be verified may be within the visual range of a second user, the Confidence Manager 2400 could send a message to a mobile device associated with the second user asking the second user if he or she can see the first user. The Confidence Manager 2400 could also request the second user to take some other action that would provide data suitable to verify the first user's location, such as taking a picture of the first user or taking a voice recording of or near the first user.

In one embodiment, if a first user or a first user's device supplies corroborating location data for a second user, Confidence Manager 2400 could reward the first user for consistent and reliable responses to such requests or reduced in reputation or reliability rating for failing to respond or for reports that later are proved likely to have been false (or fraud). In some embodiments, verification sources may be monetarily compensated while in others a points, scoring, reputation or reliability rating.

In one embodiment, the Confidence Manager 2400 can be configured to constantly designate, track and update a list of immediately available verification sources, including overseeing any terms associated with use of that source. As users locations change and corroborating sources come and go, the Confidence Manager 2400 can maintains a prioritized list of contact information for verification sources. For example, monetarily compensated verification sources may, for example, be given a higher certification rating that non-monetarily compensated sources because of the additional protections against fraud in commerce created by that transaction.

The Communications Manager 2500 serves as the Verified Presence Tracking Engine's interface to sensor 2700 and communications networks 2800 and supplies location data relating to registered users to the Location Tracking Manager 2300 and the Confidence Manager 2400.

Note that internationally, the collection, storage and dissemination of location data is heavily regulated in some jurisdictions. As such, the physical configuration of a Verified Presence Tracking Service and a Verified presence Tracking Engine as shown in FIG. 1 and FIG. 3 may need to be adapted to regulatory constraints. In some cases, location data may need to be sourced from third party providers authorized by a target jurisdiction. In some cases, sensors from which location data may be acquired, locations from where location data may be acquired, transmission paths for location data, points where location data is stored, and points where location data is cached may need to be fine-tuned to meet regulatory requirements.

Note that a Location Tracking Engine 2000 with limited functionality could also be implemented as a self-contained PIM application or process for only handling a user's own location requests relating only to the user's devices, e.g. synchronization and cross-platform applications or interdevice communication.

### Verified Presence Data Marketplace

Verified location data is a potentially valuable commodity and even more valuable when combined with verified demographic, activity or association data for specific users in specific locations. For example, retailers may have an interest in the composition of consumers who patronize a given location and when such consumers are present in a given location, what they do while they are there and with whom they usually visit that location. Such data could be used, among other uses, to test the effectiveness of an advertising campaign or differing ad copy or commercial offers. Likewise, a municipality may have an interest in traffic patterns on a given road, public transportation route, pedestrian path and so forth as well as the demographic, activity or association composition patterns among those users.

A verified presence marketplace enables a specialized marketplace that creates an ecosystem of presence data and users, advertisers or other consuming entities in varying stages of data creation, management and consumption including data discovery, data valuation, data marketing and source matching as well as data consumption and sharing transaction data and meta-data about all of it created by its existence and ongoing processing/use. Such a marketplace can operate in conjunction with a private or personal data aggregation and analysis platforms, but such platforms are not necessary for the offering for sale, browsing, selection and consumption of verified presence data.

Verified location data, at the most basic level, originates with individual users, and such users may not, without compensation, have any interest in allowing their location data to be known to third-parties. A good deal of such data may be generated, at least in part, at user expense. For example, a user may have one or more traceable cellular devices, but the user pays for the cellular service that does the actual tracking, maintains and provides access to the generated data. Furthermore, if a user must explicitly verify his or her location, user time and effort is involved. A user must be provided with incentives to voluntarily offer up his or her location data. At a higher level, commercial services may be able to obtain location data from individual users or other sources and provide value added services, such as data aggregation and statistical analysis. Such entities could remarket aggregated, analyzed location data to other commercial entities either separately or on behalf of one or more users together or separately. Likewise, owners and/or operators of locations and sensors may generate marketable data on the users who visit or use their locations or location-based services.

In one embodiment, verified location data could be made available to interested entities through an electronic marketplace. At the core of the marketplace paradigm is a means to that allows users and commercial data aggregators to offer verified location data for sale to interested entities, either for the consumption of the entity or for aggregation, analysis and resale. In one embodiment, such a marketplace provides a mechanism for users and other entities to post offers for verified location data. In one embodiment, such offers could comprise an identification of a target user, a location data granularity level, location data reliability level and at least one payment term.

Where data originates from a specific user, the identification of a target user can comprise an identification of the user as personably identifiable, as generic or as anything in between including more detailed levels that comprise an identification of a user and a specific sensor (i.e. source of location data) such as a cell phone. Where data originates from a data aggregator, the identification of a user could comprise a group of users defined by the data aggregator (e.g. 18-24 years olds with an interest in conservation) or could be a pattern (e.g. consumers in locations in Chicago, Ill.) or even highly granular for a specific location and time (e.g. Joe's Pizza in Chicago, Friday nights, 8-10 PM). The user may prefer to restrict data offered for public consumption to data that originates from a specific sensor (e.g. the user's cell phone).

A user may only be willing to sell location data at a particular level of granularity, or may place a premium on location data offered at lower levels of granularity. For example, a user may not greatly value anonymous location data that simply indicates traffic (e.g. the number of persons present in a given location at a given time). On the other hand, the user may place a premium on detailed location data that is specifically attributed to the user (e.g. the location of the user within 100 feet in a given time interval). A data aggregator may only be willing (or able) to sell data at a particular level of granularity, or may place a premium on location data offered at lower levels of granularity. For example, a data aggregator may value, at a lower level, data that represents an aggregation of anonymous traffic, but may value, at a higher level, lists of individual consumers, that patronize a given location.

The value of data is tied, to a greater or lesser extent, to its reliability. The cost of location data rises with its reliability. The most reliable location data may require manual validation by one or more individuals, or may require that multiple data sources be analyzed to verify a given user or group of user was present at a given location at a given time. An offer of location data must explicitly or implicitly provide a minimum guarantee of reliability. Thus, a user's offer of location data based on a single source (e.g. a cell phone) is less valuable than an offer that encompasses multiple sources.

Perhaps most importantly to the end user, are payment terms for location data. While it may be possible to collect anonymous traffic data for large groups of users, it may be necessary (or at least desirable) to collect location data relating to specific users with user consent. There is little motive for such consent without compensation. A verified presence data marketplace can provide a mechanism for such compensation. Individual users may be offered various types of incentives such as monetary compensation, frequent shopper points, coupons and so forth. Commercial entities, such as data aggregators, would more likely require direct payment.

Data could be offered on a non-exclusive, “for-sale” basis, which is to say, any entity willing to pay for the data could be given the opportunity to purchase the data. On the other hand, data could be offered on an exclusive basis to the highest bidder. In one embodiment, much like current keyword bidding for CPC campaigns, bidding could be real-time or near time, and entities interested in location data could compete with one another on a continuing basis.

Offers to supply location data could be further qualified. In one embodiment, offers to supply location data could be limited to specific temporal or spatial limitations. For example, an offer to supply location data could specify that the offer only applies to location data collected from 8:00 AM to 5:30 PM, Monday through Friday. In another example, an offer to supply location data could specify that the offer only applies to location data collected in a given geographic location. Offers to supply location data could also be for a given time-slice, or could, alternatively, be real-time.

A system for marketing verified presence data could accumulate location data at the lowest level of granularity available and associate levels of reliability to individual datums, but may not necessarily publish data at such levels. Location data may be published at a level of granularity requested by data purchasers or at level authorized by data publishers (e.g. users). Furthermore, location data may be published, where appropriate, on a real-time basis.

A marketplace for verified presence data allows interested entities to bid for verified location data for target users. Such bids could comprise an identification of an entity, an identification of target users, location data granularity levels, location level reliability levels and payment offers. The identification of target users could specify where an entity is interested in data from individual users, bids for data from such users. Where an entity is interested in aggregated statistics for groups of users, bids could be placed for aggregated user data to data aggregators.

Bids for location data could be automatically accepted where the supplier of location data has provided sufficient information for bids to be accepted without user input. For example, in the case of non-exclusive offers where the user specifies specific payment terms, any bids which meet offer payment terms may be accepted. A verified presence marketplace could additionally automatically accept, on behalf of users, bids for exclusive access to user location data where bid payment terms meet offer payment terms. A verified presence marketplace could additionally automatically accept, on behalf of users, the highest bid for exclusive access to user location data where bid payment terms exceed offer payment terms.

Alternatively, a verified presence data marketplace could provide means whereby a location data provider could review various bids for location data and accept those which the provider chooses. For example, a location data provider may offer location data at a given rate per user per instance, but a bidder may offer to pay for the same data at a lower rate or may bid for data at a lower level of granularity or reliability. Bids could also be exclusive or non-exclusive, and/or could offer compensation on alternative terms (e.g., offer is monetary, but bid is in frequent shopper points). An entity interested in location data could even bid for data that is not currently offered. For example, a verified presence marketplace could be aware of users who fit a given demographic profile and could forward bids for location data to such users.

A verified presence marketplace could additionally provide enhanced value by linking presence data to other types of user data. For example, the marketplace could maintain, or have access to, user profile data. Such profile data could provide, among other things, user demographics, and data extracted from user interaction data (e.g. emails and text messages). In one embodiment, a verified presence marketplace could offer entities seeking location data the ability to search for location data offers based on user demographics. Such additional data could also include user interaction data which includes data extracted from user email, instant messages, text messages, post on social networking sites, and so forth. For example, a verified presence marketplace service could record user interest in a certain kind of music as associated to being present is specific locations, as determined by user's actual interaction data with music in locations.

In one embodiment, standardized data structures could be populated with information, for example, by mobile applications, and transmitted periodically to a verified presence marketplace. In one embodiment, third party applications may make use of an API to the mobile-resident application, to increase the quality and volume of useful information. For example, a photo application on a phone can transmit a photo to another user or to a central photo repository. At the same time, the photo app will construct metadata about the presence of the photo, about recipients, time of day, location, and co-location. When the photo is sent (or even if it is not) this rich set of metadata is communicated via API to the verified presence marketplace

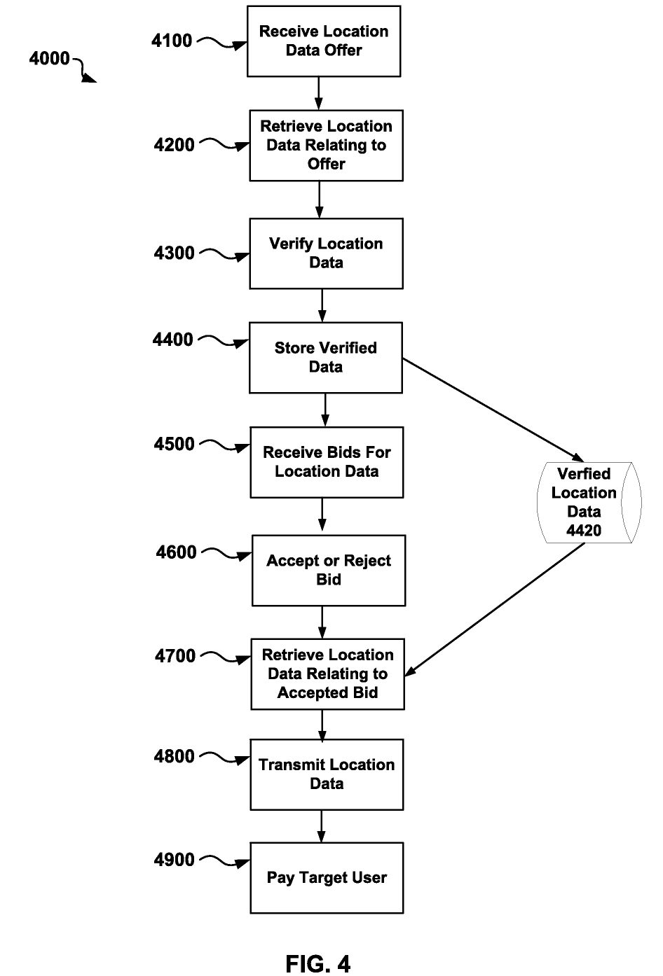

FIG. 4 illustrates one embodiment of a process 4000 for a verified presence data marketplace.

At least one offer is received 4100, over a network, for verified location data 4100. Each offer comprises an identification of at least one target user, at least one data granularity level, at least one data reliability level and at least one payment term.

The identification of a user could comprise an identification of a single user known to at least one data source. For example, the user could be a single user of a cellular phone. Alternatively, the identification of a user could comprise sufficient information to identify a group of users, for example, users between the ages of 15-25 on the west coast. Where data originate with a data aggregator, the data aggregator could offer data for classes of users, for example, location data for users between the ages of 18 and 25.

The granularity of location data offers could vary. Location data could offer location data for a specific user within, for example, a 10 foot radius. On the other hand, a user could offer anonymous location data. The value of such data will vary based on the data consumer. For example, a retail store may only be interested in the total volume of consumers who visit a given location, whereas another retail store may be interested in the identity of consumers who visit a given location. In another example, a municipality may be interested in pedestrian traffic on a given street, whereas a given business may be interested in traffic passing the a specific location for the business.

Offers can include additional offer terms that further qualify the offer. Offer terms could specify that data is offered on an exclusive highest bid basis. Offer terms could specify that data is offered on a non-exclusive basis which is to say, any entity willing to pay for the data could be given the opportunity to purchase the data. Offer terms could specify temporal and/or spatial limitations. For example, an offer to supply location data could specify that the offer only applies to location data collected in a given geographic location or a given time-slice, or could, alternatively, be real-time. In one embodiment, offers for location data could include abstract renditions of a user's demographic information

Once offers for location data for a user have been received, location data for the users can be retrieved from a plurality of location data sources. Such data may be retrieved 4200 from any data source known to the system that has location data relating to the user (as described in detail above). In one embodiment, the reliability of the location data is then verified 4300 using the techniques described in detail above and the data is stored 4400 on a computer readable medium 4420, such as a database. In one embodiment, the verified location data is stored in association with the identification of the users to which the data relate, the granularity of the location data and the reliability of the location data. Alternatively, data offered in an offer for location data could be retrieved on a real-time basis after there is a winning bid.

Offers for location data may be displayed, in one form or another, such that interested entities can view the offers and place bids relating to the offers. Such offers may be displayed through a user interface, or alternatively, may be supplied through a data feed. Bids in response to the offers can then be received 4500. In one embodiment, such bids can comprise an identification of the entity bidding for location data, an identification of target users, data granularity levels, data reliability levels and at least one payment offer. Bids could additionally specify a data volume. Payment offers could be cash, incentive points, “credits” on the location tracking system (e.g. ability to submit location data requests free of charge). The location tracking service could accept, reject or defer acting on any given bid including various incentivizing of location data sources.

In one embodiment, where there is more than one bidder, the highest bidder may get all the data, or more detailed information may be provided depending on the bid, e.g. fully personal identifiable for the first place bidder, anonymized data for the second place bidder, and aggregated data for the third place bidder. In another embodiment, each type of data, personally identifiable, anonymous and aggregated are different marketplaces/products and support separate bidding ecosystems.

In one embodiment, the system could further provide a reverse auction capability whereby companies can bid for user's data even in the absence of outstanding offers. For example, means could be provided whereby companies wishing to market to a given user can view abstract renditions of the user's information and offer the compensation for fuller access and/or for the right to make specific product offers.

Bids for location data can then be accepted or rejected 4600 on behalf of users. In one embodiment, where bids for location data meet offer terms, the offers can be automatically accepted on behalf of the user based. Alternatively, a user may explicitly accept or reject bids for location data. For example, a verified presence marketplace could provide a user interface whereby users are enabled to view bids for their location data and accept or reject such bids. In one embodiment, where bids for location data do not meet offer terms, such offers can be displayed to users or other entities offering location data for review and acceptance or rejection. Where location data is offered in a data auction, the highest bidder may be chosen on behalf of the data offeror.

Bids could specify a data volume and a minimum reliability. Payment could be cash, incentive points, “credits” on the location tracking system (e.g. ability to submit location data requests free of charge). The location tracking service could accept, reject or defer acting on any given bid including various incentivizing of location data sources.

The acceptance of bids could be automated based on an acceptance profile. The system could further analyze patterns of location data demand and adjust maximum payment based on demand for data relating to specific individuals, groups of individuals, activities and environmental or social context (or both) of the source and/or target.

Once a bid for verified location data has been accepted, the location data can then be retrieved 4700 from the computer readable medium 4420 where such data is stored. Initially such data may be retrieved at the lowest (most detailed) level available, and then modified or summarized according to bid or offer terms. The data can then be transmitted 4800 to the requesting entity. When location data has been transmitted to a bidding entity, the user or other entity to which the location data relates is then paid 4900.

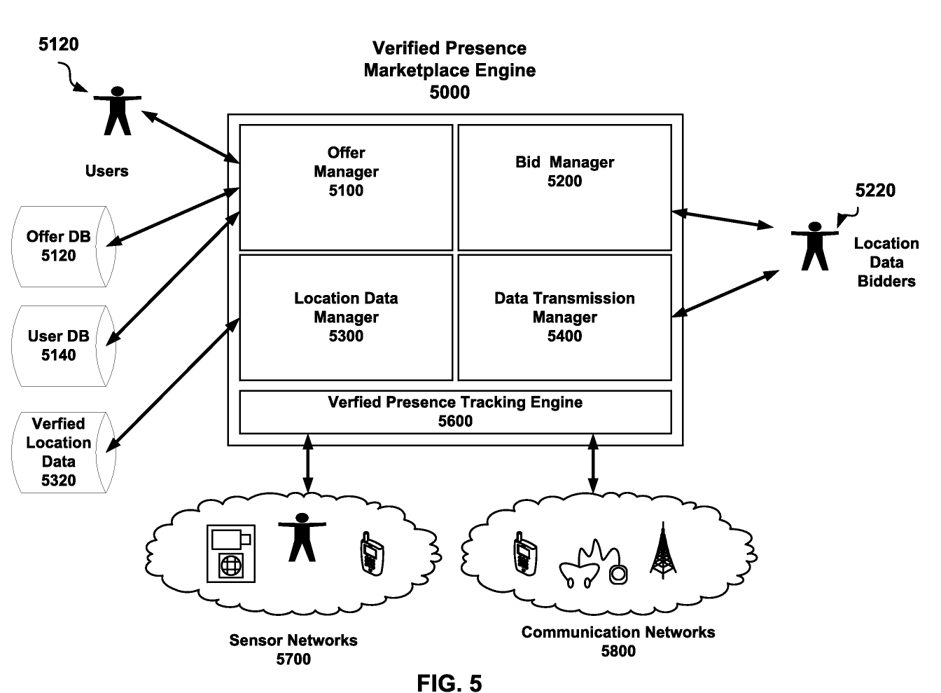

FIG. 5 illustrates one embodiment of a verified presence data market engine 5000 capable of supporting embodiments of the process shown in FIG. 4.

In one embodiment, the a verified presence marketplace engine 5000 comprises an Offer Manager 5100, a Bid Manager 5200, a Location Data Manager 5300 and a Data Transmission Manager 5400. In one embodiment, the verified presence data market engine 5000 could incorporate the functionality of a Verified Presence Tracking Engine 5600, or alternatively, could be interface with a verified presence tracking engine or could itself be a component of a verified presence tracking engine.

In one embodiment, each of the managers comprises one or more processors programmed to execute software code retrieved from a computer readable storage medium storing software for functions as described below. In one embodiment, each of the modules could be hosted on one or more servers hosted by a verified presence tracking service 100 or a verified presence marketplace service 150 shown in FIG. 1. Such an embodiment is purely exemplary, and all of the managers shown could be implemented in any combination on any number of servers, as will be readily apparent to those skilled in the art.

The Offer Manager 5100 is configured to receive offers for verified location data from users 5120. In one embodiment, each offer comprises an identification of at least one target user, at least one data granularity level, at least one data reliability level and at least one payment term. The identification of a user could comprise an identification of a single user known to at least one data source. For example, the user could be a single user of a cellular phone. Alternatively, the identification of a user could comprise sufficient information to identify a group of users. Where data originate with a data aggregator, the data aggregator could offer data for classes of users. In one embodiment, offers for location data could include abstract renditions of a user's demographic information and could include basic terms for which a user is willing to sell location information.

In one embodiment, the Offer Manager 5100 stores offers on an offer database 5120. In one embodiment, the Offer Manager 5100 stores additional information regarding users in a user information database 5140. Such information can include user profile information and demographics. In one embodiment, the Offer Manager 5100 provides at least one user interface that allows interested parties to browse offers and search for specific categories of users.

The Bid Manager 5200 is configured to receive bids, over a network, for verified location data offers from bidders 5220. In one embodiment, such bids can comprise an identification of the entity bidding for location data, an identification of target users, data granularity levels, data reliability levels and at least one payment offer. Bids could additionally specify a data volume. Payment offers could be cash, incentive points, “credits” on the marketplace. The Bid Manager 5200 could accept, reject or defer acting on any given bid including various incentivizing of location data sources.

In one embodiment, the Bid Manager 5200 is configured to accept bids on behalf of users. In one embodiment, where bids for location data meet offer terms, the offers can be automatically accepted on behalf of the user. Alternatively, the Bid Manager 5200 could provide a user interface that allows users to view bids for their location data and accept or reject such bids. In one embodiment, where bids for location data do not meet offer terms, such offers can be displayed to users or other entities offering verified location data for review and acceptance or rejection. Where location data is offered in a data auction, the Bid Manager 5200 can be configured to automatically choose the highest bidder the highest bidder may be automatically chosen on behalf of the data offeror.

In one embodiment, where there is more than one bidder for a given offer, the Bid Manager 5200 can be configured such that the highest bidder gets all the data, or more detailed information can be provided depending on the bid. In one embodiment, the Bid Manager 5200 can be configured to provide a reverse auction capability whereby entities can bid for user's data even in the absence of outstanding offers.

The Location Data Manager 5300 is configured to retrieve location data relating to offers from a plurality of location data sources 5700 and 5800. Such data may be retrieved from any data source known to the system that has location data relating to the user as described above. The Location Data Manager 5300 is further configured to verify the reliability of the location data using, for example, the techniques described above. In one embodiment, Location Data Manager 5300 interfaces with a Verified Presence Tracking Engine 5600 such as that described above in order to obtain verified location data. In one embodiment, Location Data Manager 5300 is further configured to store location data on a computer readable medium, such as a database 5320. In one embodiment, the verified location data is stored in association with the identification of the associated users, the granularity of the location data and the reliability of the location data. Alternatively, Location Data Manager 5300 could be configured to retrieve location data on a real-time basis after the acceptance of a bid.

The Data Transmission Manager 5400 is configured to retrieve location data for accepted bids from the location database 5320. Initially such data may be retrieved at the lowest (most detailed) level available, and then modified or summarized according to bid or offer terms. The Data Transmission Manager 5400 is further configured to transmit the retrieved location data to the bidding entities. The Data Transmission Manager 5400 is further configured to pay the user or other entity to which the data relates according to the terms of accepted bids.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

We claim:

1. A method comprising the steps of:
receiving, over a network, at least one offer for verified location data, wherein each offer comprises an identification of at least one target user, at least one offer data granularity level, at least one offer data reliability level and at least one offer payment term;
retrieving, over a network, location data relating to the at least one offer target user from a plurality of location data sources;
verifying, using at least a first computing device, the reliability of the retrieved location data;
storing, using at least a second computing device, the verified location data on a computer readable medium, wherein the verified location data is stored in association with the identification of the at least one target user, a location data granularity level, and a location data reliability level;
receiving, over a network, at least one bid for verified location data from an entity, wherein the bid relates to the at least one offer for verified location data, wherein each bid comprises an identification of the entity, an identification of at the least one target user, at least one bid data granularity level, at least one bid data reliability level and at least one payment offer;
processing, using at least a third computing device, an acceptance of the at least one bid for verified location data;
retrieving the verified location data relating to the at least one bid for verified location data from the computer readable medium;
transmitting, over the network, the verified location data relating to the at least one bid for verified location data to the entity, wherein the data is transmitted at the least one bid data granularity level and the at least one bid data reliability level;
paying, using at least a fourth computing device, the at least one target user according to the terms of the at least one payment offer.

2. The method of claim 1 wherein the first, second, third and fourth computing device are the same computing device.

3. The method of claim 1 wherein the location data relating to the at least one target user is not retrieved until the acceptance of the at least one bid for verified location data is processed.

4. The method of claim 1 wherein the acceptance of the at least one bid for verified location data is received, over a network, from the at least one target user.

5. The method of claim 1 wherein the acceptance of the at least one bid for verified location data is automatically generated, using the at least a third computing device, when the at least one payment offer of the at least one bid for verified location data meets or exceeds the at least one payment term of the at least one offer.

6. The method of claim 1 wherein at least two bids are received relating to the at least one offer for verified location data, and wherein an acceptance of one of the at least two bids is automatically generated, using the at least a third computing device, for the bid having the highest at least one payment offer

7. The method of claim 1 wherein identification of the at least one target user comprises an identification of the user and a sensor.

8. The method of claim 1 wherein identification of the at least one target user comprises an identification of a group of users.

9. The method of claim 1 wherein the offer additionally comprises at least one spatial limitation, and only location data that meets the at least one spatial limitation is retrieved.

10. The method of claim 1 wherein the offer additionally comprises at least one temporal limitation, and only location data that meets the at least one temporal limitation is retrieved.

11. The method of claim 1 wherein the at least one offer is exclusive.

12. The method of claim 1 wherein the at least one offer is non-exclusive.

13. The method of claim 1 wherein the at least one offer additionally comprises at least one type of information selected from the list:
demographic information, activity information and association information

14. The method of claim 1 wherein the at least one bid for verified location data additionally comprises a data volume.

15. The method of claim 1 wherein the at least one payment offer is selected from the list: cash, incentive points, and credits on a location tracking system.

16. A method comprising the steps of:
receiving, over a network, at least one bid for verified location data from an entity wherein each bid comprises an identification of the entity, an identification of at the least one target user, at least one bid data granularity level, at least one bid data reliability level and at least one payment offer;
processing, using at least a first computing device, an acceptance of the at least one bid for verified location data;
retrieving, over the network, location data relating to the at least one target user from a plurality of location data sources;
verifying, using at least a second computing device, the reliability of the retrieved location data;
storing, using at least a second computing device, the verified location data on a computer readable medium, wherein the verified location data is stored in association with the identification of the at least one user, the granularity of the location data and the reliability of the location data;
processing, using at least a third computing device, an acceptance of the at least one bid for verified location data;
retrieving the verified location data relating to the at least one bid for verified location data from the computer readable medium;
transmitting, over the network, the verified location data relating to the at least one bid for verified location data, wherein the data is transmitted at the least one bid data granularity level and the at least one bid data reliability level;
paying, using at least a fourth computing device, the at least one target user according to the terms of the at least one payment offer.

17. The method of claim 16 wherein the first, second, third and fourth computing device are the same computing device.

18. A system comprising:
an offer manager comprising one or more processors programmed to execute software code retrieved from a computer readable storage medium storing software for receiving, over a network, offers for verified location data, wherein each offer comprises an identification of at least one target user, at least one data granularity level, at least one data reliability level and at least one payment term;
a location data manager comprising one or more processors programmed to execute software code retrieved from a computer readable storage medium storing software for retrieving, over a network, location data relating to target users from a plurality of location data sources, verifying the reliability of the retrieved location data and storing the verified location data on a second computer readable medium, wherein the verified location data is stored in association with an identification of at least one target user, at least one data granularity level, and at least one data reliability level;
a bid manager comprising one or more processors programmed to execute software code retrieved from a computer readable storage medium storing software for receiving, over a network, bids for verified location data from entities, wherein each bid relates to the at least one offer for verified location data, wherein each bid comprises an identification of the entity, an identification of at the least one target user, at least one bid data granularity level, at least one bid data reliability level and at least one payment offer, the bid manager being further configured to process acceptances of bids for verified location data; and
a data transmission manager comprising one or more processors programmed to execute software code retrieved from a computer readable storage medium storing software for retrieving verified location data relating to accepted bids from the second computer readable medium, for transmitting such verified location data to entities whose bids have been accepted and for paying target users according to the terms of the accepted bids.

19. The system of claim 18 wherein the location data retrieved by the location data manager relating to target users is not retrieved until an acceptance of at least one bid for such data has been processed by the bid manager.

20. The system of claim 18 wherein for at least some of the acceptances of bids for verified location data are received, over a network, from the target users.

21. The system of claim 18 wherein at least some acceptances of bids for verified location data are automatically generated by the bid manager when the payment offers of bids for verified location data meets or exceeds payment terms of offers.

22. The system of claim 18 wherein, at least two bids are received relating to at least one offer for verified location data, and wherein an acceptance of one of the at least two bids is automatically generated by the bid manager for the bid having the highest at least one payment offer

23. The system of claim 18 wherein, for at least some offers, the identification of the at least one target user comprises an identification of the user and a sensor.

24. The system of claim 18 wherein, for at least some offers, the identification of the at least one target user comprises an identification of a group of users.

25. A computer-readable medium having computer-executable instructions for a method comprising the steps of:
receiving, over a network, at least one offer for verified location data, wherein each offer comprises an identification of at least one target user, at least one offer data granularity level, at least one offer data reliability level and at least one offer payment term;
retrieving, over a network, location data relating to the at least one offer target user from a plurality of location data sources;
verifying, using at least a first computing device, the reliability of the retrieved location data;
storing, using at least a second computing device, the verified location data on a second computer readable medium, wherein the verified location data is stored in association with the identification of the at least one target user, a location data granularity level, and a location data reliability level;
receiving, over a network, at least one bid for verified location data from an entity, wherein the bid relates to the at least one offer for verified location data, wherein each bid comprises an identification of the entity, an identification of at the least one target user, at least one bid data granularity level, at least one bid data reliability level and at least one payment offer;
processing, using at least a third computing device, an acceptance of the at least one bid for verified location data;
retrieving the verified location data relating to the at least one bid for verified location data from the second computer readable medium;
transmitting, over the network, the verified location data relating to the at least one bid for verified location data to the entity, wherein the data is transmitted at the least one bid data granularity level and the at least one bid data reliability level;
paying, using at least a fourth computing device, the at least one target user according to the terms of the at least one payment offer.

26. The computer-readable medium of claim 25 wherein the first, second, third and fourth computing device are the same computing device.

27. The computer-readable medium of claim 25 wherein the location data relating to the at least one target user is not retrieved until the acceptance of the at least one bid for verified location data is processed.

28. The computer-readable medium of claim 25 wherein the acceptance of the at least one bid for verified location data is received, over a network, from the at least one target user.

29. The computer-readable medium of claim 25 wherein the acceptance of the at least one bid for verified location data is automatically generated, using the at least a third computing device, when the at least one payment offer of the at least one bid for verified location data meets or exceeds the at least one payment term of the at least one offer.

30. The computer-readable medium of claim 25 wherein at least two bids are received relating to the at least one offer for verified location data, and wherein an acceptance of one of the at least two bids is automatically generated, using the at least a third computing device, for the bid having the highest at least one payment offer

31. The computer-readable medium of claim 25 wherein identification of the at least one target user comprises an identification of the user and a sensor.

32. The computer-readable medium of claim 25 wherein identification of the at least one target user comprises an identification of a group of users.
